(19) United States
(12) Patent Application Publication
(10) Pub. No.: US 2009/0019984 A1
(43) Pub. Date: Jan. 22, 2009

(54) PICK GUARD FOR A GUITAR

(76) Inventor: Richard Ouellette, Moncton (CA)

Correspondence Address: Richard Ouellette, 14 Firwood Crescent, Moncton, E1A 5X2, CA

(21) Appl. No.: 11/780,469

(22) Filed: Jul. 19, 2007

(51) Int. Cl. G10D 3/00; B29C 35/02

(52) U.S. Cl. 84/291; 264/552

(57) ABSTRACT

A pick guard for a guitar comprises a main body having a front surface and a back surface, and a peripheral edge adjoining the front surface and a back surface. At least a substantial portion of the main body comprises a doming mixture. There is also a guitar contact portion having a front surface and a back surface, and a peripheral edge adjoining the front surface and a back surface. An adhesive is on the back surface of the guitar contact portion. The front surface of the guitar contact portion may include a graphic image.

### FIELD OF THE INVENTION

The present invention relates to pick guards, and more particularly to pick guards for guitars, which pick guards are made from an epoxy, polyurethane or other liquid resin mixtures and materials, and which harden to predetermined customizable shapes.

### BACKGROUND OF THE INVENTION

Guitars are stringed musical instruments wherein sound is produced by the vibrations of a plurality taut strings that are strung over most of the length of the body and neck of the guitar. The body of the guitar is typically made from wood, and has a outer protective finish of laquer, varnish, or any other suitable material.

The vibrations are produced either by either ones fingertips, or preferably by a pick, plectrum, or the like, held by ones fingers and thumb. The pick is drawn across one or more of the strings of the musical instrument at a time, in a plucking or strumming manner to play music.

While strumming the strings of a guitar, it is common for the guitar pick make contact with the front face of the guitar in a location somewhat below the strings, as the strumming motion carries through beyond the strings. While this does not necessarily affect the actual playing of the guitar, it can cause surface damage to the front face of the guitar. Accordingly, it is common for guitars to have a plastic pick guard mounted on the front face of the guitar, So as to be lower than the strings when a guitar is held in its normal playing position, and adjacent the sound hole of an acoustic guitar, so as to preclude the impact of a guitar pick against the finished wood of the front face of the guitar.

Various types of guitar pick guards are known and maybe made from various types of suitable plastic materials or from suitable metal materials. These guitar pick guards maybe secured to the front surface of a guitar by a suitable adhesive, by threaded fasteners, or by merely removably hooking it to the guitar, at various features of the guitar, such as the sound hole.

United States Published Patent Application Number 2005/0241456 published Nov. 3, 2005 to Nakamura et al discloses Multi-Layer Pick Guard Devices and Methods Therefor. The pick guard device that comprises a pick guard assembly having a multiplicity of layers. Each layer is coupled to an adjacent layer of a multiplicity of layers. The backside of the final layer of the multiplicity of layers is detachably coupled to a portion of the surface adjacent to the sound hole of the guitar, thereby enabling a person to non-adhesively couple the pick guard device to the surface adjacent to the sound hole and also to non-destructively decouple the pick guard device from the surface adjacent to the sound hole. The pick guard device may be replaced with another pick guard device as desired. The multi-layer pick guard is made from a thermal plastic material, such as polyethylene, polypropylene, polyester, and polyvinyl chloride.

U.S. Pat. No. 6,723,908 issued Apr. 20, 2004 to Chapman et al, discloses a Pick Guard with Electronic Control Housing and Interface for Acoustic Guitar. The pick guard has a flat surface for mounting to the sound board of a musical instrument such as a guitar. Electronic components are mounted within a housing of the pick guard. The pick guard is made from a plastic polymer material, or can be made from wood, light metal materials, rubber, or other synthetic or composite materials.

U.S. Pat. No. 5,517,891 issued May 21, 1996 to Sica discloses a Guitar Pick Guard. This guitar pick guard is for mounting on the front surface of an electric guitar between the neck and the bridge. The guitar pick guard has a top layer, a bottom layer, and middle layer. The top layer is made of fabric. The bottom layer is made of a soft felt material. The middle layer is made a flexible rubber, plastic or vinyl material. Threaded fasteners are used to secure the guitar pick guard to the body of the guitar.

These above discussed pick guards have a number of disadvantages associated with them. First, if they are made from a plastic material and are injection molded, such prior art pick guards require expensive dies or molds to attain the desired size and shape of pick guard. This is often too cost prohibitive to use for small production runs of custom shape pick guards. Indeed, it would be almost unjustifiable to have a customized shape or size of pick guard if it was made by means of injection molding.

Further, if the pick guard is made from a plastic material or a metal material, or is made from a combination of materials, where the pick guard must be cut and formed and assembled, it would be prohibitively expensive to manufacture as the manufacturing process is very labour intensive.

Further, with the above discussed methods and means of manufacturing, it is difficult and time consuming, and therefore expensive, to prepare certain shapes of guitar pick guards, especially intricate shapes. Indeed, many shapes are not possible with present conventional pick guards.

Also, it is difficult to manufacture pick guards having a customized pattern or picture, or the like, using conventional manufacturing methods and means. Additionally, it is difficult to print full color photographic quality pictures on conventional plastic pick guards. Most conventional pick guards are made from colorful plastic material, and are of one or more colors. Often, such guitar picks have a single color design printed thereon. It is not known in the prior art to produce guitar pick guards having full color photographic quality pictures on them.

Further, it is difficult to produce a completely transparent pick guard by utilizing the standard pick guard manufacturing processes presently available. It is not known to produce a pick guard having a photograph or other article, such as a momento or coins, that are readily viewable. Having a viewable photograph, or similar, within the guitar pick guard, is highly desirable as it would allow for the production guitar pick guards having pictures of favourite musicians or groups, album covers or alternatively other subject matter such as logos of sports teams or pictures of professional athletes, and so on.

It is an object of the present invention to provide guitar pick guards made from a doming mixture.

It is another object of the present invention to provide guitar pick guards made from a doming mixture, which guitar pick guards do not require expensive molds and dies.

It is another object of the present invention to provide guitar pick guards made from a doming mixture, which guitar pick guards may be economically produced in small batches.

It is a further object of the present invention to provide guitar pick guards made from a doming mixture, which guitar pick guards can readily be made in customized shapes.

It is a further object of the present invention to provide guitar pick guards made from a doming mixture, which guitar pick guards can readily be made in virtually any shape.

It is a further object of the present invention to provide guitar pick guards made from a doming mixture, wherein it is not cost prohibitive to produce small production runs of custom shape guitar pick guards.

It is a further object of the present invention to provide guitar pick guards made from a doming mixture, which guitar pick guards have a customized pattern or picture on them.

It is a further object of the present invention to provide guitar pick guards made from a doming mixture, which guitar pick guards have from one colour to full colour photographic quality pictures on them.

It is a further object of the present invention to provide guitar pick guards made from a doming mixture, which guitar pick guards are partially to completely transparent.

It is a further object of the present invention to provide guitar pick guards made from a doming mixture, wherein the pattern on guitar pick guards are partially to completely printed.

### SUMMARY OF THE INVENTION

In accordance with one aspect of the present invention there is disclosed a novel pick guard for a guitar. The pick guard comprises a main body having a front surface and a back surface, and a peripheral edge adjoining the front surface and a back surface. At least a substantial portion of the main body comprises a doming mixture.

In accordance with another aspect of the present invention there is disclosed a novel pick guard for a guitar. The pick guard comprises a guitar contact portion having a front surface and a back surface, and a peripheral edge adjoining the front surface and a back surface. An adhesive is on the back surface of the guitar contact portion.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described herein below.

### BRIEF DESCRIPTION OF THE DRAWINGS

The novel features which are believed to be characteristic of the guitar pick guard according to the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only, and are not intended as a definition of the limits of the invention. In the accompanying drawings:

FIG. 1 is a perspective view of the first preferred embodiment of the guitar pick guard according to the present invention, in place on a guitar;

FIG. 2 is a perspective view of the first preferred embodiment guitar pick guard of FIG. 1;

FIG. 3 is a top plan view of the first preferred embodiment guitar pick guard of FIG. 2;

FIG. 4 is a side elevational view of the first preferred embodiment guitar pick guard of FIG. 2;

FIG. 5 is a bottom plan view of the first preferred embodiment guitar pick guard of FIG. 2;

FIG. 6A is a side elevational view of the second preferred embodiment guitar pick guard according to the present invention;

FIG. 6B is a top plan view of the third preferred embodiment guitar pick guard according to the present invention;

FIG. 7 is a top plan view of the method of forming a guitar pick guard according to the present invention, showing the graphic images and the shape and size of a pick, formed on a guitar contact portion;

FIG. 8 is a top plan view of one piece of the guitar contact portion of FIG. 7, cut out to the shape and size of a guitar pick guard;

FIG. 9 is a top plan view of a plurality of the guitar contact portions of FIG. 8, placed in a curing tray; and,

FIG. 10 is a perspective view of one of the plurality of the guitar contact portions of FIG. 8, and showing a resin mixture being introduced onto the front face of the guitar contact portion, to form a similar shape guitar pick guard.

### DETAILED DESCRIPTION OF THE PREFERRED EMBODIMENTS

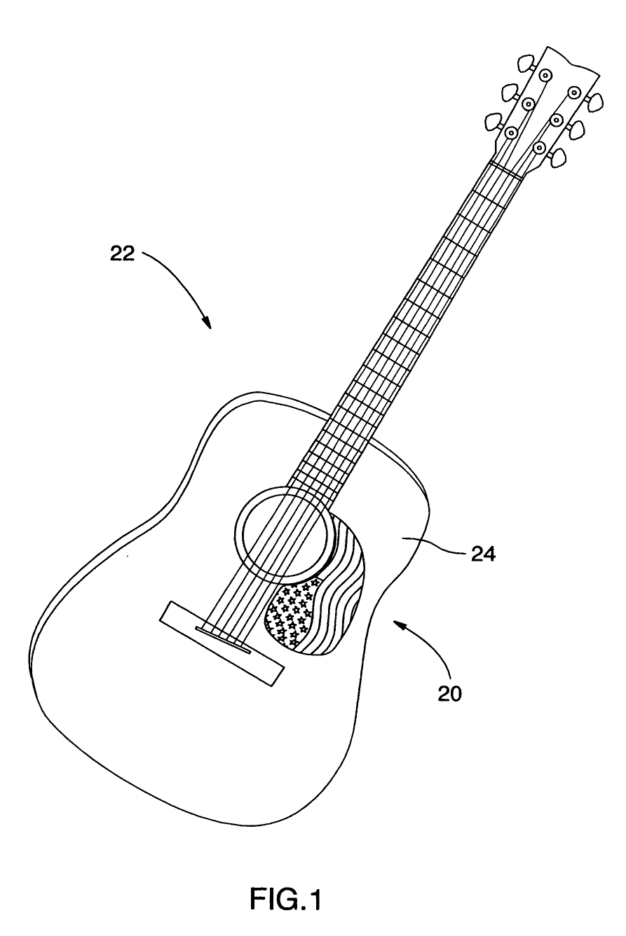

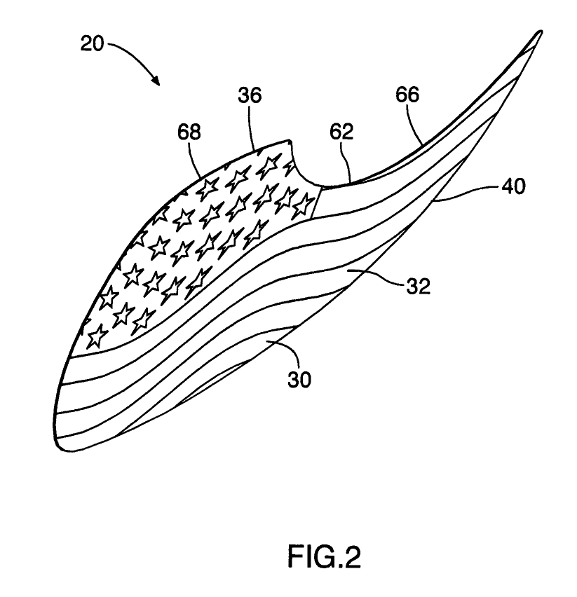

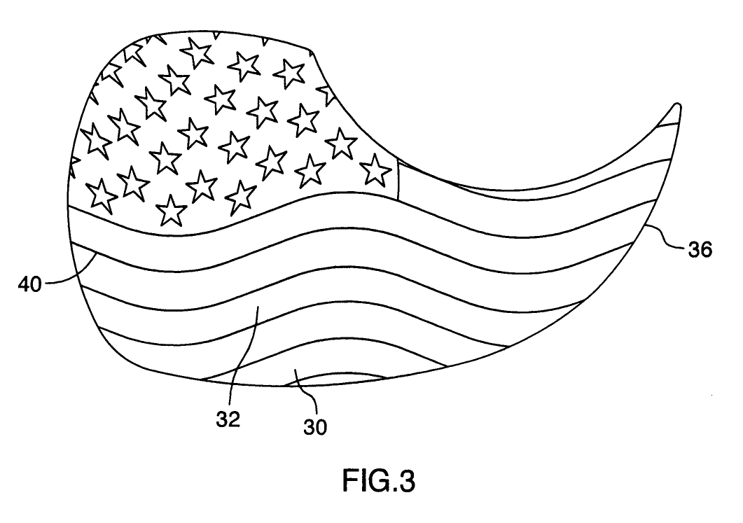

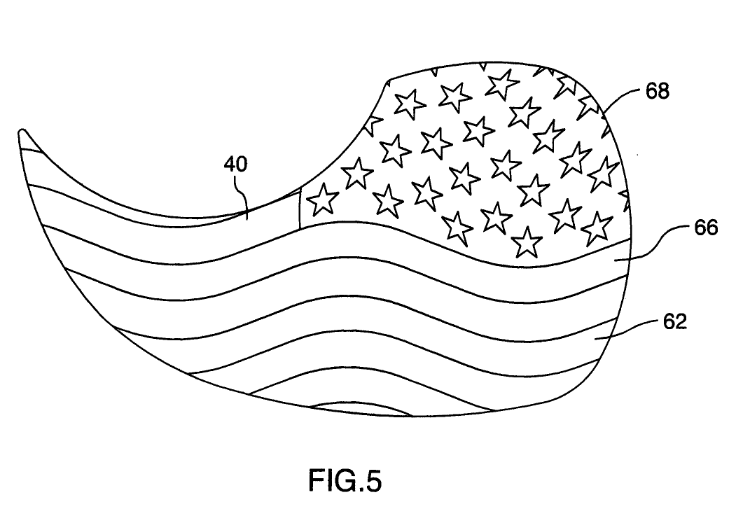

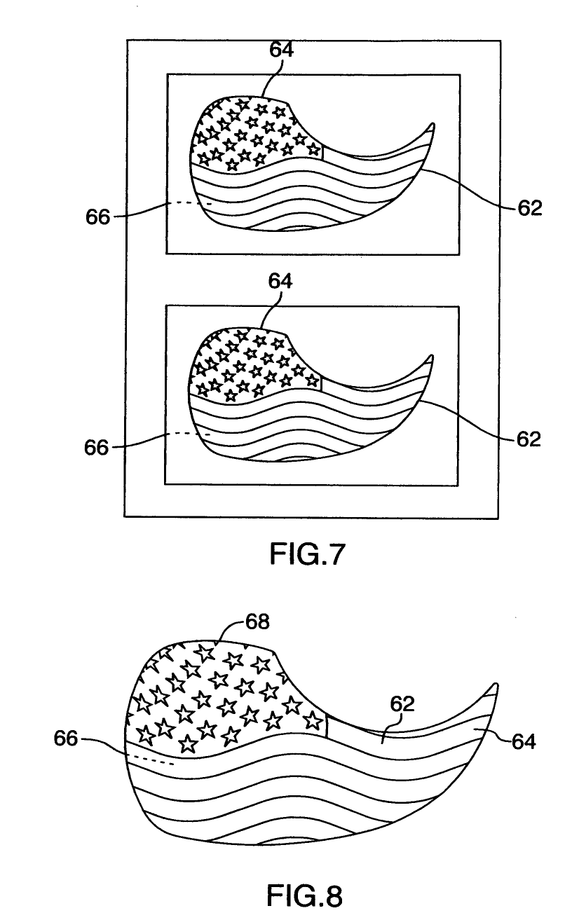

Referring to FIGS. 1 through 10 of the drawings, it will be noted that FIGS. 1 through 5 illustrate a first preferred embodiment of the guitar pick guard according to the present invention, FIG. 6A illustrates a second preferred embodiment of the guitar pick guard according to the present invention, FIG. 6B illustrates a third preferred embodiment of the guitar pick guard according to the present invention, and FIGS. 7 through 10 illustrate a method of forming a guitar pick guard according to the present invention.

Reference will now be made to FIGS. 1 through 5, which show a first preferred embodiment of the guitar pick guard of the present invention, as indicated by general reference numeral 20. The guitar pick guard 20 is for placing on the front face 24 of a guitar 22, so that the front face of the guitar will not be damaged by the action of the guitar pick carrying through after a strumming or picking motion.

The first preferred embodiment guitar pick guard 20 comprises a main body 30 having a front surface 32 and a back surface 34, and a peripheral edge 36 adjoining the front surface 32 and a back surface 34. The peripheral edge 36 can be any suitable shape for a guitar pick guard 20. At least a substantial portion of the main body 30 comprises a doming mixture, which is preferably a resin mixture. Preferably at least a substantial portion of the main body 30 comprises epoxy resin. The first preferred embodiment guitar pick guard 20 according to the present invention is made from an epoxy resin, a polyurethane resin, or other liquid resin mixtures and materials which harden to predetermined customizable shapes.

As can be readily seen in the figures, especially in FIG. 4, the front surface 32 of the main body 30 is substantially dome shaped, but typically only slightly dome shaped due to the ratio of the overall length and width of the guitar pick guard 20 as compared to the relatively small thickness. This dome shape results from the manufacturing operation, as will discussed subsequently. Further, the back surface 34 of the main body 30 is substantially flat. The peripheral edge 36 adjoining the front surface 32 and the back surface 34 has a slight vertex at initial formation, as can be seen in FIG. 4.

The guitar pick guard 20 of according to the present invention further comprises a guitar contact portion 62 having a front surface 64, a back surface 66, and a peripheral edge 68 adjoining the front surface 64 and the back surface 66. The guitar contact portion 62 is secured to the back surface 34 of the main body 30, such that the front surface 64 of the guitar contact portion 62 is against the back surface 34 of the main body 30 by means of a suitable adhesive 69. Preferably, but not necessarily, the guitar contact portion 62 is thin and flexible, so that the main body 30 forms the major portion of the guitar pick guard 20. The guitar contact portion 62 is best made from a water resistant material, such as vinyl or waterproof paper. If the guitar contact portion 62 is made from a vinyl material, then the guitar pick guard 20 may be adhered to a guitar by means of static adhesive, due to the properties of the material.

The guitar pick guard 20 further comprises an adhesive 69 on the back surface 66 of the guitar contact portion 62. The adhesive 69 comprises one of a releasable adhesive and a permanent adhesive. A releasable adhesive is used so that the guitar pick guard 20 can be readily removed from a guitar, if desired. In this manner, the guitar pick guard 20 can be used on a number of guitars, or various ones of the guitar pick guard 20 can be used on a single guitar, and so on. A permanent adhesive is used if the guitar pick guard 20 is to remain permanently on the guitar and not be removed. The static adhesive is used so that the guitar pick guard 20 can be readily removed from a guitar, if desired.

As can readily be seen in FIGS. 1, 2, 3 and 5, the front surface 64 of the guitar contact portion 62 includes a graphic image 40. This graphic image 40 might be of a musical artist or band, or may be of a professional team, or might even be a company logo, or even any picture, as desired.

In the first preferred embodiment, as illustrated, the entire main body 30 of the guitar pick guard 20 comprises a resin mixture, preferably epoxy resin. The epoxy resin is substantially clear, or in other words transparent, such that the graphic image 40 on the front surface of the guitar contact portion 62 is against the back surface 34 of the main body 30, and can be readily viewed from the front of the guitar pick guard 20.

Reference will now be made to FIG. 6A, which shows a second preferred embodiment of the guitar pick guard 220 according to the present invention. The second preferred embodiment guitar pick guard 220 is similar to the first preferred embodiment guitar pick guard 20, except that the guitar pick guard 220 comprises a guitar contact portion 262 having a front surface 264 and a back surface 266, and a peripheral edge 268 adjoining the front surface 264 and the back surface 266. As in the first preferred embodiment guitar pick guard 20, there is an adhesive on the back surface 264 of the guitar contact portion 262, either a releasable adhesive or a permanent adhesive 269. Similarly, the guitar contact portion is thin and flexible. Also, the the front surface 264 of the guitar contact portion 262 includes a graphic image 240, and the guitar contact portion 262 is substantially clear so that the graphic image 240 may be viewed.

Reference will now be made to FIG. 6B, which shows a third preferred embodiment of the guitar pick 320 according to the present invention. The third preferred embodiment guitar pick 320 is similar to the first preferred embodiment guitar pick guard 20, except that it is of a different shape, and covers more of the front surface of a guitar, including some of the area on the upper side of the strings and sound hole.

Reference will now be made to FIGS. 7 to 10, which show a method of forming the guitar pick guard 20 according to the present invention. The method comprising the following steps that will now be described in detail.

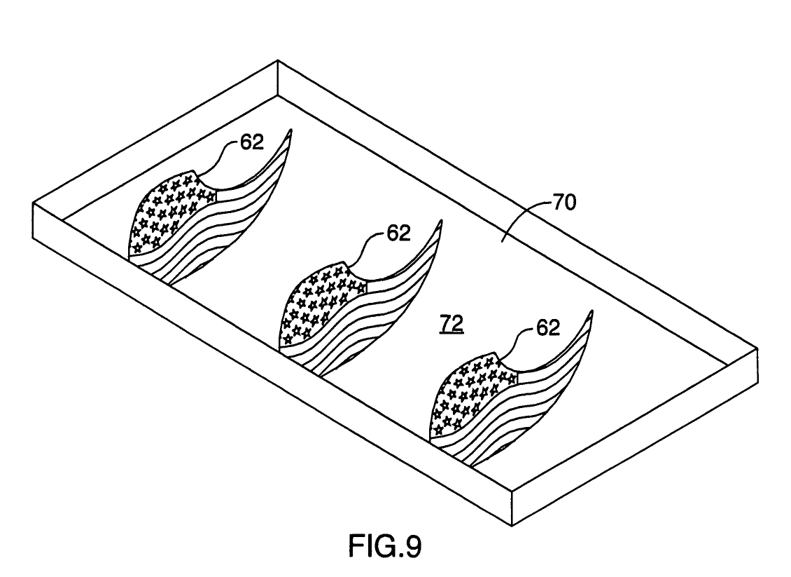

First, a guitar contact portion 62 is provided. As illustrated in FIG. 7, each guitar contact portion 62 is cut from a sheet of print media 60. Preferably, the guitar contact portion 62, shown separately in FIG. 8, has a front face 64 and a back face 66, and is made from a water resistant material, such as vinyl or waterproof paper. The guitar contact portion 62 preferably has a special coating on it to absorb and retain ink that forms a graphic image 68 that will be disposed on the front surface 64 of the guitar contact portion 62 against the main body 30 of the guitar pick guard 20. Accordingly, the step of providing a guitar contact portion 62 for the pick 20 may also comprise printing the graphic image 40 onto the contact portion 62.

The graphic image 40 on guitar contact portion 62 might be related to music, such as a musical artist or band, or might be a professional team, a company logo, and so on, as desired. Preferably, the graphic image 40 is made from a water resistant ink, so that the graphic image 40 does not run.

Next, the guitar contact portion 62 is cut into a pre-determined shape. More specifically, the guitar contact portion 62 as shown in FIG. 7 is cut into a number of predetermined shapes, such as the shape shown in FIG. 8.

As can be seen in FIG. 9, the guitar contact portions 62 are placed onto a curing tray 70 with the back face 66 of each guitar contact portion 62 against the curing tray 70 and the front face 64 of each guitar contact portion 62 facing generally upwardly. Preferably, the curing tray 70 comprises an adhesive curing tray 70, or in other words has a mildly adhesive upwardly facing receiving surface 72 that keeps the guitar contact portions 62 in place absolutely flat on the curing tray 70.

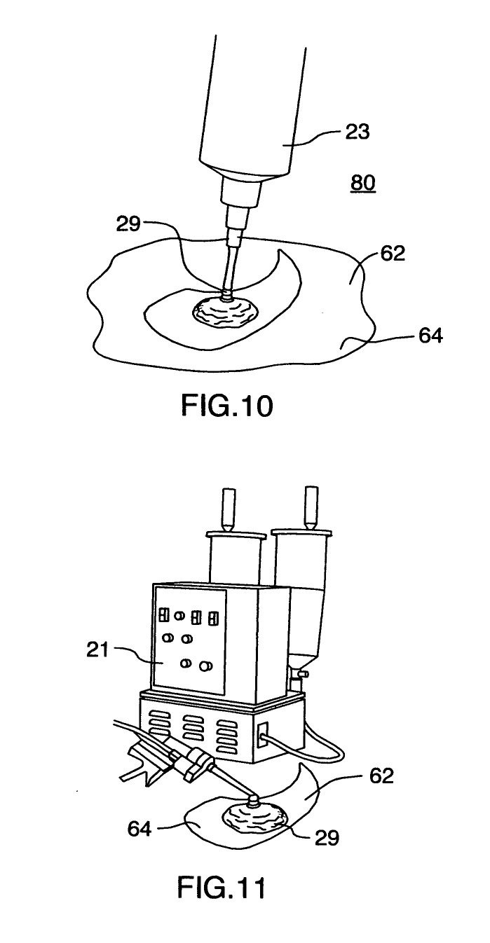

Next, as can be seen in FIG. 10, a doming mixture, which is preferable, a resin mixture, is carefully introduced onto the front face 64 of the guitar contact portion 62. The resin mixture, which is preferably a liquid epoxy resin, as indicated by the reference numeral 29, is reasonably viscous, and accordingly flows slowly to the outer edge of the guitar contact portion 62. Surface tension causes of the liquid epoxy resin 29, which of course is the doming mixture, to stop at the outer edge of the guitar contact portion 62, thus defining and forming the main body 30 of the guitar pick guard 20. Accordingly, the main body 30 of the guitar pick guard 20 will have the same shape as the guitar contact portion 62. The doming material can also be polyurethane, or any other suitable material.

Preferably, but not necessarily, the step of introducing the doming mixture 29 onto the top surface of the guitar contact portion 62 is performed with a syringe device 23. Other suitable methods they also be used. As shown in FIG. 11, the step of introducing the doming mixture 29 onto the top surface of the guitar contact portion 62 is performed with automated doming machine equipment 21. Also, the step of introducing the doming mixture 29 onto the guitar contact portion 62 is performed in an environmentally controlled area 80, in order to control temperature, dust and humidity.

The resin mixture 29 is then permitted to cure, typically over a period of eight to twelve hours, thus forming a hardened resin mixture guitar pick guard 20 comprising the main body 30 with its front surface 32, back surface 34, and peripheral edge 36, and the guitar contact portion 62 having a front surface 64, a back surface 66, and a peripheral edge 68.

The ink that forms the graphic image 68 on the guitar contact portion 62 can be seen through the main body 30 of the guitar pick guard 20 as a graphic image 40. The graphic image 40 can be viewed from above the domed top surface of the guitar pick guard 20, thus providing a highly aesthetic quality to the guitar pick guard 20. Utilizing this new manufacturing method, photo quality images may be introduced onto the guitar pick guard 20.

At this point, the guitar pick guard 20 is in a finished form, as is shown in FIGS. 1 through 5, and is therefore usable without further modification. By using our new manufacturing technique, small custom shape runs can be prepared using a printer/media cutting device (not specifically shown) or plotter to determine the specific size and shape of the guitar pick guard 20 without use of expensive dyes or production molds. The doming mixture is poured on to the precut guitar contact portion 62 and hardens to the exact size and shape of the guitar contact portion 62.

As can be understood from the above description and from the accompanying drawings, the present invention provides guitar pick guards made from resin such as epoxy resin or polyurethane resin, which guitar pick guards do not require expensive molds and dies, wherein it is not cost prohibitive to produce small production runs of custom shape guitar pick guards, which guitar pick guards can be readily made in virtually any shape and have full color photographic quality pictures on them, and can be completely transparent, all of which features are unknown in the prior art.

Other variations of the above principles will be apparent to those who are knowledgeable in the field of the invention, and such variations are considered to be within the scope of the present invention. Further, other modifications and alterations may be used in the design and manufacture of the guitar picks 20 and 50 of the present invention without departing from the spirit and scope of the accompanying claims.

I claim:

1. A pick guard for a guitar, said pick guard comprising:
a main body having a front surface and a back surface, and a peripheral edge adjoining said front surface and a back surface;
wherein at least a substantial portion of said main body comprises a doming mixture.

2. The pick guard for a guitar of claim 1, wherein the entire main body comprises a doming mixture.

3. The pick guard for a guitar of claim 1, wherein said doming mixture comprises a resin mixture.

4. The pick guard for a guitar of claim 3, wherein said resin mixture comprises one of an epoxy resin and a polyurethane resin.

5. The pick guard for a guitar of claim 1, wherein said front surface of said main body is substantially dome shaped.

6. The pick guard for a guitar of claim 1, wherein said back surface of said main body is substantially flat.

7. The pick guard for a guitar of claim 1, further comprising a guitar contact portion having a front surface and back surface, and a peripheral edge adjoining said front surface and a back surface, and wherein said guitar contact portion is secured to said back surface of said main body, such that said front surface of said guitar contact portion is against said back surface of said main body.

8. The pick guard for a guitar of claim 7, wherein said guitar contact portion is thin and flexible.

9. The pick guard for a guitar of claim 8, further comprising an adhesive on said back surface of said guitar contact portion.

10. The pick guard for a guitar of claim 9, wherein said adhesive comprises one of a releasable adhesive and a permanent adhesive.

11. The pick guard for a guitar of claim 7, wherein said guitar contact portion is made from a vinyl material.

12. The pick guard for a guitar of claim 7, wherein said front surface of said guitar contact portion includes a graphic image.

13. The pick guard for a guitar of claim 12, wherein said doming mixture is substantially clear.

14. A pick guard for a guitar, said pick guard comprising:
a guitar contact portion having a front surface and a back surface, and a peripheral edge adjoining said front surface and said back surface;
adhesive on said back surface of said guitar contact portion.

15. The pick guard for a guitar of claim 14, wherein said guitar contact portion is thin and flexible.

16. The pick guard for a guitar of claim 14, wherein said front surface of said guitar contact portion includes a graphic image.

17. The pick guard for a guitar of claim 14, wherein said guitar contact portion is substantially clear.

18. The pick guard for a guitar of claim 14, wherein said adhesive comprises one of a releasable adhesive, a permanent adhesive, and a static adhesive.

19. The pick guard for a guitar of claim 14, wherein said guitar contact portion is made from a vinyl material.

20. A method of forming a pick guard for a guitar, said method comprising the steps of:
providing a guitar contact portion having a front face and a back face;
placing the guitar contact portion onto a curing tray with said back face against the curing tray and said font face facing generally upwardly;
introducing a doming mixture onto said front face of said guitar contact portion;
permitting said doming mixture to cure, thus forming a hardened pick guard having a bottom surface and a domed top surface; and,
removing said hardened pick guard and guitar contact portion from said curing tray.

21. The pick guard for a guitar of claim 20, wherein said doming mixture comprises a resin mixture.

22. The pick guard for a guitar of claim 20, wherein said doming mixture comprises one of an epoxy resin and a polyurethane resin.

23. The pick guard for a guitar of claim 20, wherein said front surface of said main body is substantially dome shaped.

24. The method of claim 20, wherein said guitar contact portion includes a graphic image.

25. The method of claim 20, wherein the step of introducing said doming mixture onto said guitar contact portion is performed with a syringe device.

26. The method of claim 20, wherein the step of introducing said doming mixture onto said guitar contact portion is performed with automated doming machine equipment.

27. The method of claim 20, wherein the step of introducing said doming mixture onto said guitar contact portion is performed in an environmentally controlled area.

28. The method of claim 20, wherein said curing tray comprises an adhesive curing tray.

29. The method of claim 20, further comprising the step of cutting said guitar contact portion into a pre-determined shape.
